(19) United States
(12) Patent Application Publication
(10) Pub. No.: US 2023/0241825 A1
(43) Pub. Date: Aug. 3, 2023

(54) SYSTEM AND METHOD OF CORRECTING INJECTION MOLD ALIGNMENTS

(71) Applicant: FLEX LTD, Singapore (SG)

(72) Inventors: Javier Antoñana, Gorraiz (ES); Javier Berro, Pamplona (ES); Felix Galé, Mutilva (ES); Luis Larumbe, Pamplona (ES); Yann Le Bronnec, Lekunberri (ES); Francisco Javier Pérez Gil, Mutilva (ES)

(21) Appl. No.: 18/011,049

(22) PCT Filed: Jun. 15, 2021
(86) PCT No.: PCT/IB2021/055286

§ 371 Date: Dec. 16, 2022

Related U.S. Application Data
(60) Provisional application No. 63/040,981, filed on Jun. 18, 2020.

(51) Int. Cl. B29C 45/76; B29C 45/36; B29C 45/26

(52) U.S. Cl. CPC B29C 45/7686; B29C 45/36; B29C 45/261; B29C 45/768; B29C 2945/7629; B29C 2945/76103; B29C 2945/76588; B29C 2945/76745; B29C 2945/76936

(57) ABSTRACT

A method employing a corrector busing including measuring plastic parts produced by a plastic injection mold, adjusting one or more corrector bushings based on any measured errors in the plastic parts, performing a test production run of plastic parts, measuring the parts produced by the test production run, and determining whether the plastic parts produced by the test production run are within tolerance.

### CROSS-REFERENCE TO RELATED APPLICATIONS

This application is a 371 application of PCT/IB2021/055286 filed Jun. 15, 2021 which claims benefit of and priority to U.S. Pat. Application Serial No. 63/040,981 filed Jun. 18, 2020, the disclosures of the above-identified applications are hereby incorporated by reference in their entirety.

### BACKGROUND

When forming plastic parts via injection molding techniques, particularly tapered or cylindrical plastic parts alignment for straightness and concentricity can be a very important consideration for proper construction. There have been a number of prior devices and systems for improving this alignment, but the primary alignment tool is the high quality and close tolerance machining practices. As can be appreciated, high quality and close tolerance machining increases the costs of mold manufacturing. Further, in some instances due to the nature of the product being thermoformed, the resulting product still cannot meet the design tolerances of the product for its intended use. Accordingly, improvements are needed.

### SUMMARY

One aspect of the disclosure is directed to a method including: measuring plastic parts produced by a plastic injection mold, adjusting a corrector bushing based on any measured errors in the plastic parts, performing a test production run of plastic parts in the injection mold, measuring the parts produced by the test production run, and determining whether the plastic parts produced by the test production run are within tolerance.

Implementations of this aspect of the disclosure may include one or more of the following features. The method where adjusting the corrector bushing requires rotation of the corrector bushing. The method where rotation of the corrector bushings changes an orientation of an eccentricity of a position of an orifice in the corrector bushing. The method where the eccentricity is caused by a centerline of the orifice being spaced from a centerline of the corrector bushing. The method where the eccentricity of the corrector bushing acts on a main core of the plastic injection mold to deflect the main core in a desired direction to correct the measured errors. The method where adjusting the corrector bushing further requires replacement of the corrector bushing for one with an eccentricity sufficient to correct the measurement errors. The method where the plastic parts produced by a plastic injection mold are formed using a concentric bushing. The method further including adjusting a corrector bushing based on any measured errors in the plastic parts produced in the test production run; performing a second test production run of plastic parts in the injection mold; measuring the parts produced by the test production run; determining that the plastic parts produced by the second test production run are within tolerance; manufacturing plastic parts.

Another aspect of the disclosure is directed to a corrector bushing including: a plurality of facets, the facets configured to mate with facets of a plastic injection mold; and an orifice configured to receive a core of an injection molding machine, where the orifice is centered on a location off set from a centerline of the corrector bushing such that insertion of the core into the orifice causes the core to deflect.

Implementations of this aspect of the disclosure may include one or more of the following features. The corrector bushing where the orifice is centered on a location off set from the centerline of the corrector bushing by a predetermined eccentricity value. The corrector bushing where the orifice is centered on a location off set from the centerline of the corrector bushing by one or more microns. The corrector bushing where the orifice is configured to receive a stripper ejector. The corrector bushing where the plurality of facets mating with facets of the injection mold enable rotation of the corrector bushing, to alter the orientation of the centerline of the orifice and to adjust a direction of deflection of the core when inserted there through. The corrector bushing further including eight facets, where each facet enables a 45-degree change of orientation of the centerline of the orifice. The corrector bushing where the deflection of the core corrects the position of the core such that plastic parts formed thereon are sufficiently straight to meet a desired tolerance.

### BRIEF DESCRIPTION OF THE FIGURES

Various aspects of the present disclosure are described hereinbelow with reference to the drawings, which are incorporated in and constitute a part of this specification, wherein:

FIG. 1 is a cross-sectional view of a portion of a plastic injection mold in accordance with the disclosure;

FIG. 2A is a cross-sectional view of a bushing in accordance with the disclosure;

FIG. 2B is a perspective view of a bushing in accordance with the disclosure;

FIG. 3A is a side view of a plastic part formed with a straightness that is out of tolerance;

FIG. 3B is a side view of a plastic part having a straightness that is within tolerance;

FIG. 4A is perspective view of a corrector bushing in accordance with the disclosure;

FIG. 4B is a cross-section view of the corrector bushing of FIG. 4A;

FIG. 4C is an end view of the corrector bushing of FIG. 4A;

FIG. 5A is a perspective view of a plastic injection mold having the corrector bushings of FIG. 4A inserted therein;

FIG. 5B is a closer view of the plastic injection mold of FIG. 5A; and

FIG. 6 is a flow chart of a method in accordance with the disclosure.

### DETAILED DESCRIPTION

This disclosure is directed to a system and method enabling the individual correction of a plastic injection mold to improve the plastic parts straightness and the concentricity of long and tapered or cylindrical plastic parts. Further details and aspects of exemplary embodiments of the present disclosure are described in more detail below with reference to the appended figures.

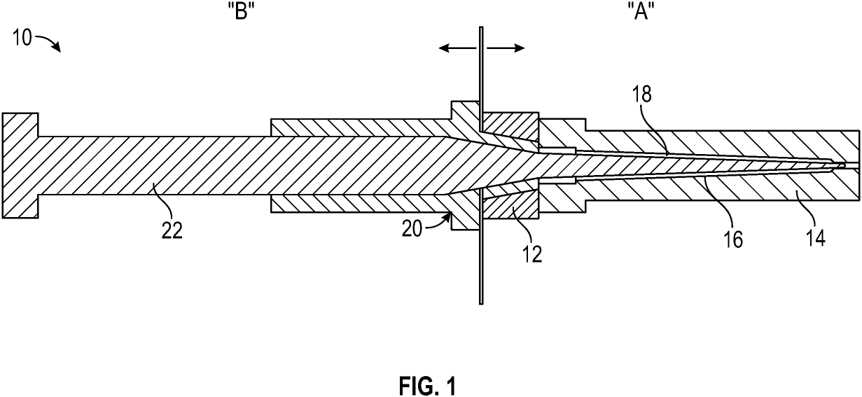

FIG. 1 depicts two sides of a plastic injection mold 10. A bushing 12 is installed on a fixed or “A” side of the plastic injection mold 10 on a platen 14 or other support structure forming a cavity 16 therein. A molded plastic part 18 is shown in the cavity 16. The moving or “B” side of the plastic injection mold 10 includes a stripper ejector 20 and a main core 22. The stripper ejector 20 has a tapered end which is shaped to receive the main core 22 of the plastic injection mold. The bushing 12 receives the stripper ejector 20 and the main core 22 when moving “B” side is brought together with the fixed “A” side as shown. A portion of the main core 22 extends into the cavity 16 and it is around this portion of the main core 22 that the plastic part 18 will be formed as molten plastic is forced into the cavity 16. After forming, the “B” side is moved away from the “A” side and the stripper ejector 20 acts on the plastic part 18 to remove the plastic part from the main core 22.

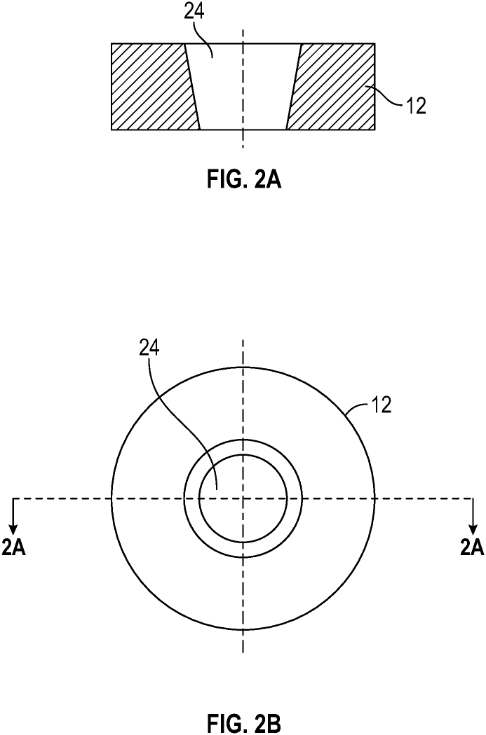

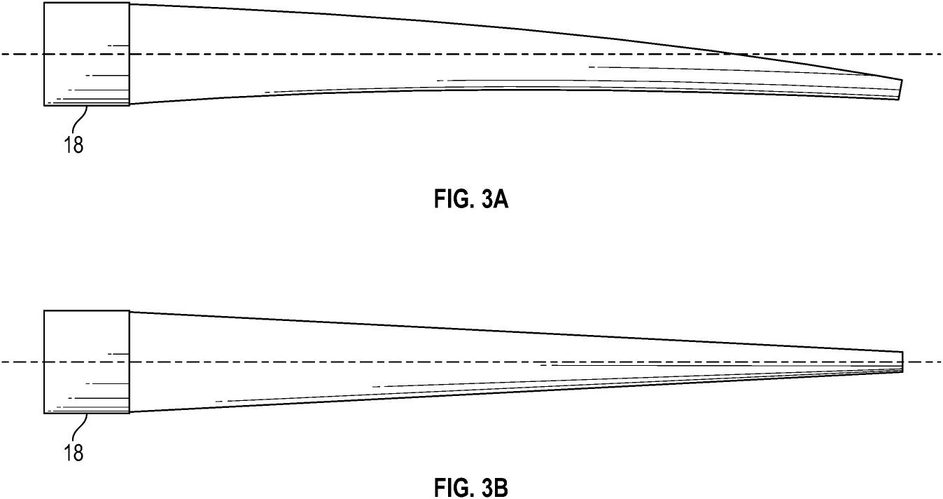

FIGS. 2A and 2B depict a standard bushing 12. The bushing 12, is formed generally round to be received in a corresponding opening in a platen 14, the orifice 24 of the bushing 12 is may also be round, as shown in FIG. 2B and tapered to receive the stripper ejector 20. The bushing 12 helps to align the main core 22 in the cavity 16 in the platen 14. However, despite the high degree of machining of the components of the plastic injection mold 10 and the care in alignment of the components, misalignments can nonetheless result is miss-formed plastic parts 18 as shown in FIG. 3A. FIG. 3B depicts a properly formed plastic part 18.

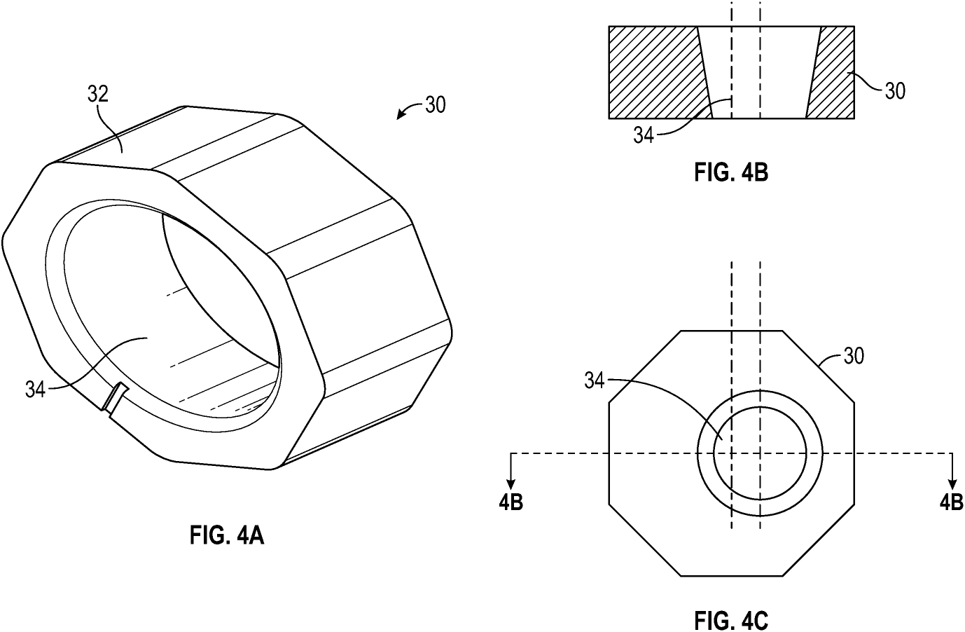

To enable correction of the plastic injection mold 10, rather than a standard bushing 12, a corrector bushing 30, as depicted in FIGS. 4A-4C may be used instead. As can be seen in FIG. 4A, the corrector bushing 30 includes a number of facets 32. In addition, the orifice 34 of the corrector bushing 30 is not formed on the centerline of the corrector bushing 30 as was seen in the bushing 12 of FIGS. 2A and 2B, but the orifice 34 is off set from the centerline in the direction of one of the facets 32 to create an eccentricity. The eccentricity can be seen in both FIGS. 4B and 4C, where the centerline of the orifice 34 is offset from the centerline of the corrector bushing 30.

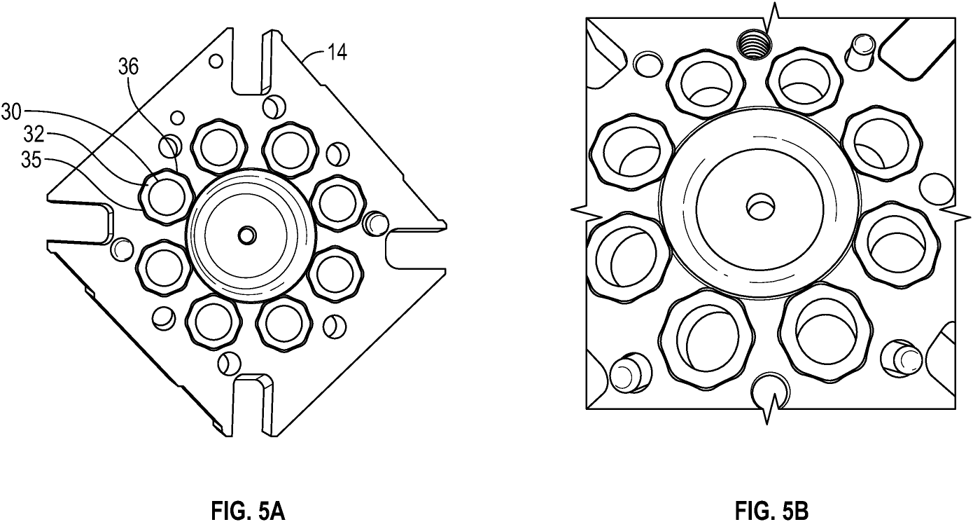

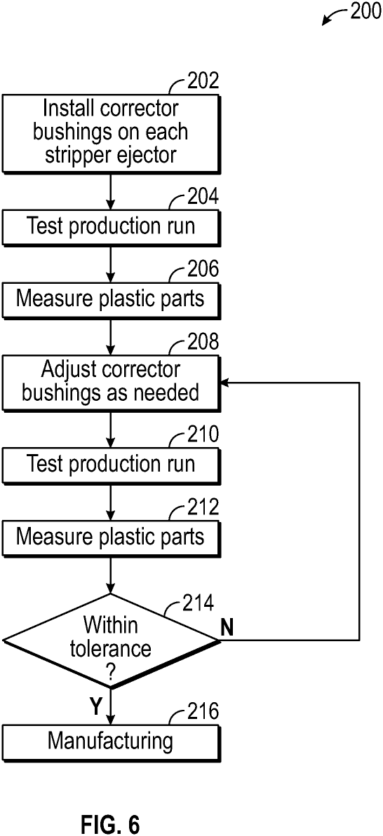

The corrector bushing 30 has a plurality of facets 32. As depicted in FIGS. 4A and 4C, the corrector bushing 30 has eight facets 32. This provides eight different orientations of the eccentricity caused by the off-center location of the centerline of the orifice 34. As can be seen with reference to FIG. 5A, the corrector bushings 30 are received in a platen 14 having openings 35 with substantially matching facets 36 as the facets 32 of the corrector bushing 30. Thus, the corrector bushing 30 has multiple mounting positions in the platen 14 or other mounting structure. Each of the mounting positions slightly varies the position of the orifice 34. Accordingly, when the moving side “B” of the plastic injection mold 10 is brought into communication with the fixed “A” side, the main core 22 is deflected by the corrector bushing 30 in the direction of the offset of the orifice 34 (i.e., in the direction of and to the amount of the eccentricity). This deflection centers the axis of the main core 22 in the cavity 16. With the eccentricity of the corrector bushing 30 properly placed, plastic parts 18 formed in the plastic injection mold can be formed properly, as depicted in FIG. 3B.

The corrector bushing 34 may have 2, 4, 6, 8, 10, 12, 14, 16 or more facets 32. The number of facets 32, provides a variable aspect to the plastic injection mold and the numbers and directions of the corrections possible for the plastic injection mold 10 to correct the alignment of a plastic part 18 formed therein. For example, a corrector bushing 34 with just four facets 32 provide for eccentricity in four directions, eight facets, provide for eccentricity in eight directions.

The corrector bushing 30 depicted in FIGS. 4A-4C has eight different mounting positions within the openings 35 of the platen 14. As a result, the corrector bushing 30 can be used to apply the single eccentricity in eight different directions by turning the corrector bushing in the opening 35 in a desired direction. In this instance each facet 32 and 36 represents a 45-degree rotation of the corrector bushing (360/8). The tightness of the tolerances and demands of the part being manufactured may determine the number of facets by having a smaller or a larger number of facets 32 in the corrector bushings 30. Further, a plastic injection mold 10 is not limited to just one or one set of corrector bushings 30, but rather a variety of different corrector bushings 30 may be created to deal with different amounts of offset of the centerline of the orifice 34 different numbers of facets depending on the application. By designing and manufacturing different corrector bushings 30 with different numbers of facets and different amounts of off set of the centerline of the orifice 34, different eccentricities can be created to enable the formation of straight parts and to compensate for any deformation by applying the required amount off set of the centerline (i.e., eccentricity), and in any direction by turning the corrector bushing 30 in the desired direction.

In FIGS. 5A and 5B, the plastic injection mold 10 includes eight openings 35, each one of which receives a corrector bushing 30. As can be appreciated, in such a plastic injection mold 10, there is the possibility that each plastic part 18 formed therein may be out of alignment in a different direction and by a different amount. Those of skill in the art will recognize that the use of the corrector bushings 30 allows the user to assess the plastic part 18 formed in each of the cavities 16 with each main core 22 and to determine the amount of off set of the centerline of the orifice 34 (eccentricity) needed and the direction of that eccentricity to achieve a straight plastic part 18.

A further aspect of the disclosure is directed to a method 200 of correcting for errors in straightness and concentricity of plastic parts 18. At step 202 side “B” of the plastic injection mold 10 is moved into position relative to side “A” with the stripper ejector 20 and the main core 22 inserted into the corrector bushing 30 and the cavity 16. Note that it is not entirely required that corrector bushings 30 be installed in the step 202, rather concentric bushings such as depicted in FIGS. 2A and 2B, with the centerline of the orifice 24 being concentric with the centerline of the bushing 12. At step 204 a test production run of the plastic parts is undertaken. Following a stabilization period, the plastic part is removed from the plastic injection mold 10 and measured for straightness and concentricity at step 206. At step 208, the results for each cavity 16 of the platen 14 are considered for straightness and concentricity between outer diameters (OD)s and inner diameter (ID) for cylindrical parts, and between the tip and the base of the part if it is conical (e.g., as shown in FIGS. 3A and 3B). With the information collected at step 208, each corrector bushing 30 in their respective openings 35 of the plastic injection mold 10 can be adjusted to apply the compensation needed for each cavity 16. This may include rotation of the corrector bushing 30 to a desired position, the exchange of the corrector bushing 30 for one affording greater deflection of the main core 22, or removal of a concentric bushing 12 and replacement with a corrector bushing 30 oriented to eliminate the out of tolerance aspects of the plastic part 18. These adjustments correct for errors in straightness and concentricity of the plastic part 18. These errors can be corrected individually for each cavity 16 of plastic injection mold 10. Again, a test production run is undertaken at step 210, and measurements on straightness and concentricity are undertaken at step 212. At step 214 a determination is made whether the plastic parts are within tolerances based on the measurements from step 212. If all the plastic parts are within tolerance, the process moves to step 216 where manufacturing runs of the plastic part 18 may be started. If the plastic parts 18 are not within tolerance method returns to step 208 and the corrector bushings 30 are again adjusted, and a further test production run is undertaken (step 210) and measurements are again taken (step 212). This may be repeated as many times as necessary to achieve plastic parts, where of sufficient quality and within the specified tolerances.

This process allows the plastic injection mold 10, and particularly the manner in which the main cores 22 are individually received within the cavities 16 of the platen 14, to be adjusted to achieve plastic parts of the desired or specified straightness and concentricity. Typically, the offset of the centerline of the orifice 34, the eccentricity value, in the corrector bushing 30 is on the order of microns, though it may be larger and will depend on the application of the component being formed, customer specifications and other factors. If the correctors bushing 30 is formed with an octagonal shape (eight facets 32) as shown in FIG. 4A will have eight different mounting positions enabling correction of the straightness of the plastic part 18 in eight different directions.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

We claim:

1. A method comprising:
measuring plastic parts produced by a plastic injection mold;
adjusting a corrector bushing based on any measured errors in the plastic parts;
performing a test production run of plastic parts in the injection mold;
measuring the parts produced by the test production run; and
determining whether the plastic parts produced by the test production run are within tolerance.

2. The method of claim 1, wherein adjusting the corrector bushing requires rotation of the corrector bushing.

3. The method of claim 2, wherein rotation of the corrector bushings changes an orientation of an eccentricity of a position of an orifice in the corrector bushing.

4. The method of claim 3, wherein the eccentricity is caused by a centerline of the orifice being spaced from a centerline of the corrector bushing.

5. The method of claim 3, wherein the eccentricity of the corrector bushing acts on a main core of the plastic injection mold to deflect the main core in a desired direction to correct the measured errors.

6. The method of claim 1, wherein adjusting the corrector bushing further requires replacement of the corrector bushing for one with an eccentricity sufficient to correct the measurement errors.

7. The method of claim 1, wherein the plastic parts produced by a plastic injection mold are formed using a concentric bushing.

8. The method of claim 1, further comprising:
adjusting a corrector bushing based on any measured errors in the plastic parts produced in the test production run;
performing a second test production run of plastic parts in the injection mold;
measuring the parts produced by the test production run;
determining that the plastic parts produced by the second test production run are within tolerance;
manufacturing plastic parts.

9. A corrector bushing comprising:
a plurality of facets, the facets configured to mate with facets of a plastic injection mold; and
an orifice configured to receive a core of an injection molding machine, wherein the orifice is centered on a location off set from a centerline of the corrector bushing such that insertion of the core into the orifice causes the core to deflect.

10. The corrector bushing of claim 9, wherein the orifice is centered on a location off set from the centerline of the corrector bushing by a predetermined eccentricity value.

11. The corrector bushing of claim 9, wherein the orifice is centered on a location off set from the centerline of the corrector bushing by one or more microns.

12. The corrector bushing of claim 9, wherein the orifice is configured to receive a stripper ejector.

13. The corrector bushing of claim 9, wherein the plurality of facets mating with facets of the injection mold enable rotation of the corrector bushing, to alter the orientation of the centerline of the orifice and to adjust a direction of deflection of the core when inserted there through.

14. The corrector bushing of claim 9, further comprising eight facets, wherein each facet enables a 45° change of orientation of the centerline of the orifice.

15. The corrector bushing of claim 9, wherein the deflection of the core corrects the position of the core such that plastic parts formed thereon are sufficiently straight to meet a desired tolerance.
